(19) United States
(12) Patent Application Publication
(10) Pub. No.: US 2021/0233130 A1
(43) Pub. Date: Jul. 29, 2021

(54) AUTOMATICALLY DETERMINING THE QUALITY OF ATTRIBUTE VALUES FOR ITEMS IN AN ITEM CATALOG

(71) Applicant: Walmart Apollo, LLC, Bentonville, AR (US)

(72) Inventors: Dantong Liu, Mountain View, CA (US); Bo Ling, Santa Clara, CA (US); Zepu Zhang, Pleasanton, CA (US); Abilash Amarthaluri, Fremont, CA (US); Benjamin Matthew Breuner, San Francisco, CA (US); Vishal Parmar, Fremont, CA (US)

(73) Assignee: Walmart Apollo, LLC, Bentonville, AR (US)

(21) Appl. No.: 16/776,138

(22) Filed: Jan. 29, 2020

(51) Int. Cl. G06Q 30/06; G06F 40/30; G06F 40/242

(52) U.S. Cl. CPC G06Q 30/0603; G06F 40/242; G06F 40/30

(57) ABSTRACT

A method including building a relevancy model based on items in an item catalog. The method also can include building a title interpreter model based on titles of the items in the item catalog. The method additionally can include retrieving target attribute values that are associated with a target attribute name of a target item in the item catalog. The target attribute values can be received from multiple sources. The method further can include generating a respective relevancy score for each one of the target attribute values using the relevancy model. The method additionally can include generating a respective precision score for the each one of the target attribute values based on the title interpreter model. The method further can include determining a respective weight for the each one of the target attribute values based on the respective relevancy score for the each one of the target attribute values and the respective precision score for the each one of the target attribute values. The method additionally can include selecting a winning attribute value for the target attribute name of the target item from among the target attribute values, based on the respective weights for the target attribute values. Other embodiments are disclosed.

### TECHNICAL FIELD

This disclosure relates generally to automatically determining the quality of attribute values for items in an item catalog.

### BACKGROUND

Items in an online items catalog generally include associated item information. This item information is often found in the form of attribute values that are associated with various attribute names. The attribute names for an item can vary based on the product type of the item. These attribute values can be populated from a variety of sources, and are not always accurate. Users often rely on the attribute values when making decisions about items in an online context.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically determining the quality of attribute values for items in an item catalog, according to an embodiment;

FIG. 4 illustrates a flow chart for a method, according to an embodiment;

FIG. 5 illustrates a flow chart for a block of building a relevancy model based on items in an item catalog, according to the embodiment of FIGS. 4; and

FIG. 6 illustrates a flow chart for a block of building a title interpreter model based on titles of the items in the item catalog, according to the embodiment of FIG. 4.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

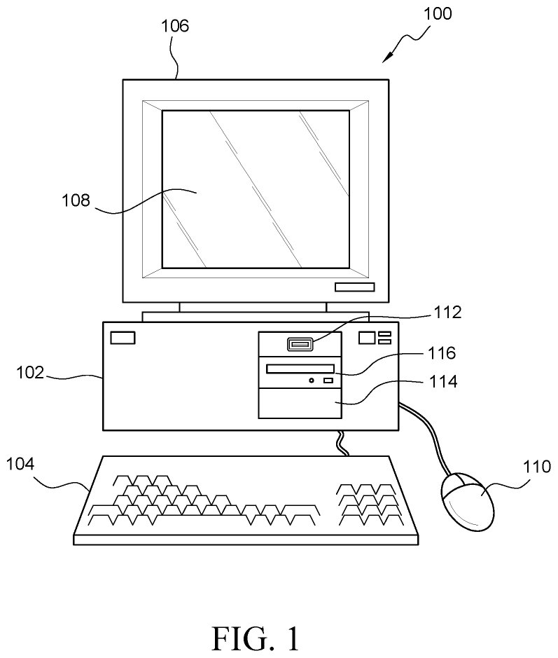

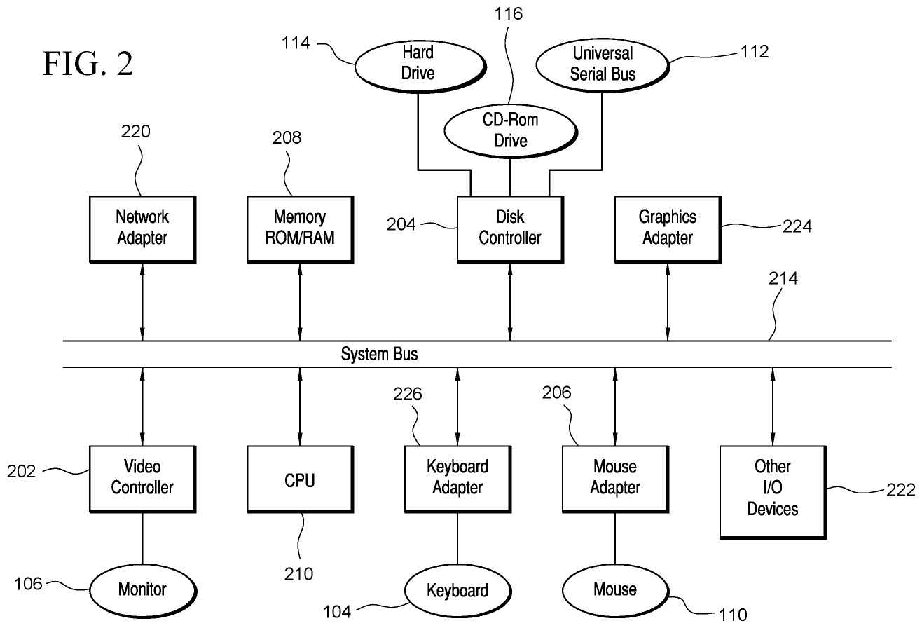

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

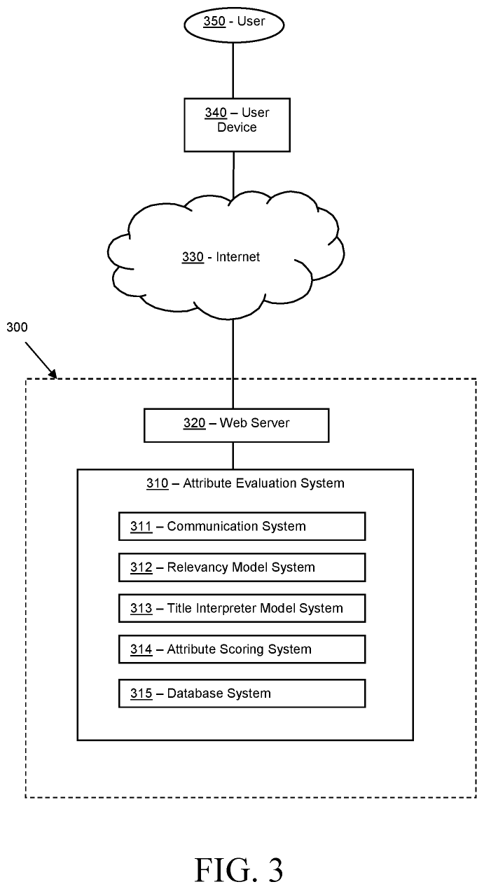

Turning ahead in the drawings, FIG. 3 illustrates a block diagram of a system 300 that can be employed for automatically determining the quality of attribute values for items in an item catalog, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an attribute evaluation system 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Attribute evaluation system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host attribute evaluation system 310 and/or web server 320. Additional details regarding attribute evaluation system 310 and/or web server 320 are described herein.

In some embodiments, web server 320 can be in data communication through Internet 330 with one or more user devices, such as a user device 340. User device 340 can be part of system 300 or external to system 300. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users to browse and/or search for items (e.g., products), to add items to an electronic cart, and/or to purchase items, in addition to other suitable activities. In a number of embodiments, web server 320 can host a website, or provide a server that interfaces with an application, on user device 340, which can allow other users, such as suppliers, to upload information about products that are being sold through web server 320. For example, users 340 can upload attribute values for items that are sold using web server 320.

In some embodiments, an internal network that is not open to the public can be used for communications between attribute evaluation system 310 and web server 320 within system 300. Accordingly, in some embodiments, attribute evaluation system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, a mobile device, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, attribute evaluation system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to attribute evaluation system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of attribute evaluation system 310 and/or web server 320. In a similar manner, the processors and/or the non-transitory computer-readable media can be local and/or remote to each other.

Meanwhile, in many embodiments, attribute evaluation system 310 and/or web server 320 also can be configured to communicate with one or more databases, such as a database system 315. The one or more databases can include a product database that contains information about products, items, or SKUs (stock keeping units), for example, including attribute names and attribute values, among other information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, attribute evaluation system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, attribute evaluation system 310 can include a communication system 311, a relevancy model system 312, a title interpreter model system 313, an attribute scoring system 314, and/or database 315. In many embodiments, the systems of attribute evaluation system 310 can be modules of computing instructions (e.g., software modules) stored at non-transitory computer readable media that operate on one or more processors. In other embodiments, the systems of attribute evaluation system 310 can be implemented in hardware. Attribute evaluation system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host attribute evaluation system 310 and/or web server 320. Additional details regarding attribute evaluation system 310 the components thereof are described herein.

In many embodiments, attribute evaluation system 310 can assess the quality of attribute values and provide suggested alternatives. In online shopping (e.g., eCommerce) platforms, users (e.g., customers) (e.g., user 350) generally rely on item information, such as attribute values for an item, when searching for items, filtering through search results, and/or making a selection (e.g., purchasing) of an item. In the online context, the users generally cannot physically hold the items that are being considered, so the users are reliant on accurate item information in making their decisions. When the item information is inaccurate, significant disadvantages, including return costs, angry customers, and/or decreased brand loyalty, can result.

For online shopping platforms that host a large number of items, such as over 200 million unique items, each having tens or hundreds of attribute values, the scale of the item catalog can be massive. With hundreds of thousand updates to attribute values being received daily, groups of humans are unable to review and validate data accuracy for all attribute values. In many embodiments, attribute evaluation system 300 can provide a technology-based solution to automatically detect data accuracy issues. These issues can then be used to flag items for further review, for example. As used herein, “quality” of an attribute value can refer to a combination of the relevancy and the accuracy of an attribute value with respect to the item with which it is associated.

Conventional system are unable to gauge the quality of attribute values, other than to determine if the attribute value is exists or not. If any attribute value is entered for a given attribute name by the sources (e.g., supplier), conventional systems assume the attribute value to be accurate, as conventional systems typically lack the ability to assess accuracy. In many embodiments, attribute scoring techniques provided by attribute evaluation system 300 can advantageously address the problem by assessing attribute value accuracy, and can provide an alternative suggested value when possible.

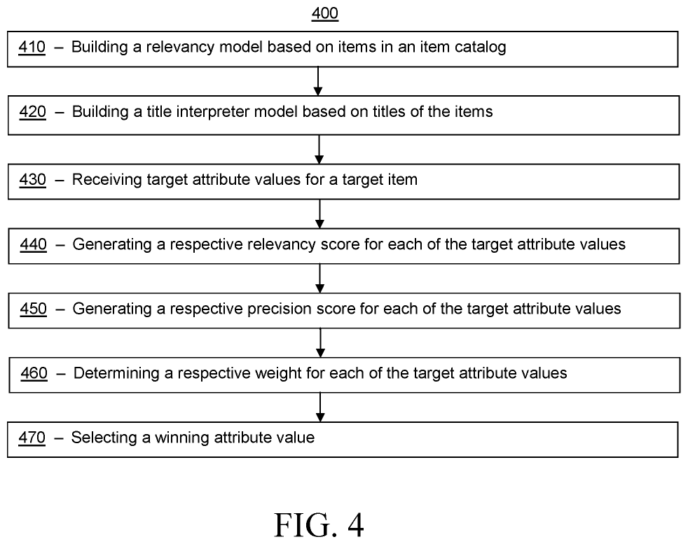

Turning ahead in the drawings, FIG. 4 illustrates a flow chart for a method 400, according to an embodiment. In some embodiments, method 400 can be a method of automatically determining the quality of attribute values for items in an item catalog. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3), attribute evaluation system 310 (FIG. 3), and/or web server 320 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of system 300. The processor(s) can be similar or identical to the processor(s) described above with respect to computer system 100 (FIG. 1).

In some embodiments, method 400 and other blocks in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include a block 410 of building a relevancy model based on items in an item catalog. After it is built, the relevancy model can be used to assess the relevancy of a given attribute value to the associated attribute name for a given item. For example, for an item that is a T-shirt, for an attribute name of color, the attribute value can be listed as “blue” from a first source, and can be listed as “teenager” from a second source. The relevancy of “blue” to the color attribute name is high for the attribute name of color in the product type of T-shirt, but the relevancy of “teenager” to the attribute name of color in the product type of T-shirt is low. The relevancy model can be built using various sources of information, include item information in the item catalog and/or taxonomy data.

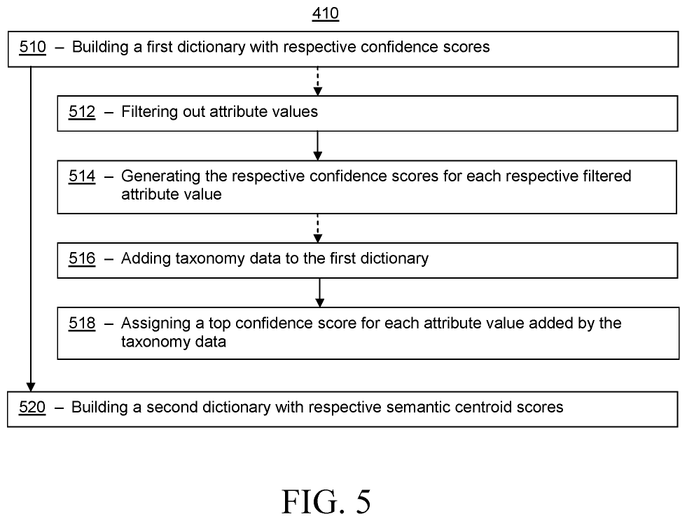

Turning ahead in the drawings, FIG. 5 illustrates a flow chart for block 410 of building a relevancy model based on items in an item catalog, according to an embodiment. Block 410 is merely exemplary and is not limited to the embodiments presented herein. Block 410 can be employed in many different embodiments or examples not specifically depicted or described herein. In some embodiments, the procedures, the processes, and/or the activities of block 410 can be performed in the order presented. In other embodiments, the procedures, the processes, and/or the activities of block 410 can be performed in any suitable order. In still other embodiments, one or more of the procedures, the processes, and/or the activities of block 410 can be combined or skipped.

Referring to FIG. 5, block 410 can include a block 510 of building a first dictionary. In many embodiments, the first dictionary can include a respective confidence score for each respective filtered attribute value that is associated with each respective attribute name that is associated with each product type of the items in the item catalog. In a number of embodiments, the first dictionary can include taxonomy data. In several embodiments, the first dictionary can be a nested dictionary.

In many embodiments, the first dictionary can be a possible value set of attribute values for each attribute name per product type using filtered catalog data, with a confidence score assigned for each attribute value. In many embodiments, the attribute values in the first dictionary can be lemmatized and concatenated attribute values, as described below. In many embodiments, the confidence score can be assigned using the term frequency-inverse document frequency (TF-IDF) technique, as described below. In a number of embodiments, the first dictionary can be updated with taxonomy data.

In many embodiments, the first dictionary can provide a mapping from an attribute value for a particular attribute name and product type to the associated confidence score. In several embodiments, the first dictionary, D₁, can have a nested structure, as follows:

```
{Product type i:
  {Attribute name j:
    {Attribute value k: confidence score k}
  }
}
```

where there is a quantity of i product types in the dictionary, with each product type having a respective quantity of j attribute names, with each of the attribute names having a respective quantity of k attribute values, and each of the attribute values being mapped to a respective confidence score. In other words, the first dictionary can include i first level blocks for each of the product types. Within each of the first level blocks for a product type can be j second level blocks for each of the attribute names associated with that product type. Within each of the second level blocks for an attribute name can be k third level blocks for each of the attribute values associated with that attribute name. The quantity values of j and/or k can vary within each outer block, depending on respective quantities of associated attribute names and associated attribute values for the product type in the item catalog. The quantity value of i can be based on the number of product types in the item catalog.

In a number of embodiments, block 510 of building a first dictionary can optionally include a block 512 of filtering out attribute values such that, for each excluded attribute value associated with an attribute name and a product type, a quantity of items associated with the excluded attribute value is fewer than a predetermined threshold. In some embodiments, the predetermined threshold can be 5 or another suitable value. In many embodiments, the respective filtered attribute values that are associated with each attribute name can be the attribute values that are not filtered out in block 512, such that the excluded attribute values are not included in the first dictionary.

For example, block 512 can be performed by collecting, by product type, all attributes name and attribute value pairs, and counting an occurrence of associated items across the item catalog. Those pairs can then be filtered to exclude those pair in which the item count is less than the predetermined threshold. This filtering can eliminate the noise in the catalog, such as attribute values that are associated with very few items. A simplified example of the collected pairs is shown below in Table 1, showing a small portion of the pairs in the collected from the item catalog:

TABLE 1

| | | | Lemmatized and | |
|---|---|---|---|---|
| | Attribute | Attribute | Concatenated | Item |
| Product Type | Name | Value | Attribute Value | Count |
| Laptop computer | brand | Dell | dell | 1000 |
| Laptop computer | brand | Generic | generic | 200 |
| Laptop computer | brand | Apple | apple | 1000 |
| T-shirts | size | Small | small | 8000 |
| T-shirts | gender | women | woman | 2 |
| T-shirts | sports team | Golden State | goldenstatewarrior | 100 |
| | | Warrior | | |

In many embodiments, the attribute value can be lemmatized and concatenated, as shown in Table 1. Lemmatizing can be performed using an conventional lemmatizing approach, such as determining the lemma for inflected forms of a word. For example, “women” can be lemmatized to “woman.” Concatenation can involve combining the individual lemmatized words into a string without spaces. For example, “Golden State Warrior” can be lemmatized to “golden state warrior,” and then concatenated to “goldenstatewarrior.” In several embodiments, the lemmatized and concatenated attribute values can provide a standard form for the attribute value when creating the pairs across the catalog, such that the item count can include the items in which the attribute value is generally the same.

As shown in Table 1, the item count for the lemmatized and concatenated attribute value of woman for the attribute name of gender and product type of T-shirts has only 2 items. This attribute value can be low, because the generally used attribute values for the attribute name of gender are male, female, and unisex, not woman. This item count of 2 is below the predetermined threshold of 5, such that this pair is filtered out and not included in the library. For the simplified example shown in Table 1, the structure of first dictionary built using the pairs, as filtered, can be as follows:

```
{‘Laptop computer’:
  {‘brand’:
    {‘dell’: <confidence score>,
    ‘generic’: <confidence score>,
    ‘apple’: <confidence score>}
    }
}
{‘T-shirts’:
  {‘size’:
    {’small’: <confidence score>}
  }
  {‘sports team’:
    {‘goldenstatewarrior’: <confidence score>}
    }
}
```

In several embodiments, block 510 of building a first dictionary also can include with a block 514 of generating the respective confidence score for the each respective filtered attribute value that is associated with the each respective attribute name that is associated with the each product type of the items in the item catalog. For example, a confidence score can be generated for each of the attribute values to be included in the first dictionary, after having performed the filtering in block 512. In many embodiments, confidence score for each respective filtered attribute value can be generated using TF-IDF to determine the respective confidence score for the each respective filtered attribute value. In many embodiments, performing TF-IDF also can help to filter out noise. In many embodiments, the TF-IDF confidence score can be generated as follows:

$$CS ( v , n , pt ) = \frac{item\_count ( v \vert n , pt )}{item\_count ( n \vert pt )} \times log ( \frac{pt\_count ( c )}{pt\_count ( n , v )} )$$

where CS(v, n, pt) is the confidence score for an attribute value v associated with an attribute name n and a product type pt, item_count is the number of unique items in the catalog that satisfy the input conditions, pt_count is the number of unique product types in the catalog that satisfy the input conditions, and c refers to the entire catalog.

As an example, consider calculating the confidence score for the attribute value “generic” for attribute name “brand” for product type “Laptop computer,” based on Table 1. The number of items having a product type of laptop computers and having “generic” as the brand is 200. The number of items having attribute name “brand” for product type “Laptop computer” is 2200, as there are 1000 items with brand of dell, 200 items with brand of generic, and 1000 items with brand of apple. The number of unique product types in the catalog is 3000 (not all shown in Table 1). The number of unique product types having attribute value of “generic” for the attribute name “brand” is 2000 (not all shown in Table 1). Accordingly, the confidence score can be calculated as follows:

CS(“generic”,“brand”,“Laptop computer”)=200/2000×log(3000/2000)=0.037

The confidence score of 0.037 is very low, indicating that “generic” is not very relevant information for indicating the brand of a laptop computer. In this manner, the confidence scores generated by TF-IDF can effectively filter out noise by providing very low scores to attribute values that are noise and not relevant. In many embodiments, this confidence score can be entered into the first dictionary D₁ for the attribute value of generic in the nested section for the attribute name of brand within the product type of Laptop computer. Confidence scores can be similarly generated for all of the attribute values in the first dictionary D₁.

In a number of embodiments, block 510 of building a first dictionary optionally can continue with a block 516 of adding taxonomy data to the first dictionary. In many embodiments, the taxonomy data can be information that was compiled previously by experts that is known to be accurate. For example, in the product type of laptop computers, an expert may have already entered eligible attribute values for the attribute name of brand, such as dell, hp, asus, lenovo, etc., as listed in their lemmatized and concatenated form. These attribute values are known to be very relevant. Often, the taxonomy data can include some of the eligible attribute values, but not necessarily all of the eligible attribute values. Further, the taxonomy data often does not include eligible attribute values for many of the attribute names in many of the product types. In many embodiments, when attribute value data in the taxonomy exists, it can be added to the first dictionary. Product taxonomy data can thus be used to supplement the first dictionary.

In several embodiments, block 510 of building a first dictionary additionally can include with a block 518 of assigning a high confidence score for each attribute value added by the taxonomy data. For example, a confidence score of 1.0 can be used for each attribute value added by from the taxonomy data, which can be a high confidence score, indicating that the attribute value is a relevant value for that attribute name within the product type.

In a number of embodiments, block 410 further can include a block 520 (after block 510) of building a second dictionary. In many embodiments, the second dictionary can include a respective semantic centroid score for the each respective attribute name that is associated with the each product type of the items in the item catalog. In many embodiments, block 520 can include determining the respective semantic centroid score for the each respective attribute name based on a weighted average of glove word embeddings for the respective filtered attributes values that are associated with the each respective attribute name. In many embodiments, the semantic centroid can be generated for an attribute name by taking a weighted average of a word embedding for each of the attribute values associated with the attribute name in the first dictionary D₁. In a number of embodiments, the weight for the weighted average can be based on item count. The word embedding can be any suitable word embedding, such as the glove word embeddings generated by GloVe: Global Vectors for Word Representation, as developed by Jeffrey Pennington, Richard Socher, and Christopher D. Manning of Stanford University.

In many embodiments, the second dictionary can provide a mapping from the attribute name to the semantic centroid score for the attribute name. In several embodiments, the second dictionary, D₂, can have a nested structure, as follows:

{Product type i:
{Attribute name j: semantic centroid score j}
}

where there is a quantity of i product types in the dictionary, with each product type having a respective quantity of j attribute names, and each of the attribute names being mapped to a respective semantic centroid score. In other words, the first dictionary can include i first level blocks for each of the product types. Within each of the first level blocks for a product type can be j second level blocks for each of the attribute names associated with that product type. The quantity value of j can vary within each outer block, depending on respective quantities of associated attribute names for the product type in the item catalog. The quantity value of i can be based on the number of product types in the item catalog.

Returning to FIG. 4, in a number of embodiments, method 400 also can include a block 420 of building a title interpreter model based on titles of the items in the item catalog. In many embodiments, the title interpreter model can extract the attribute values from the title, such as attribute values corresponding to the brand, the color, the size, and/or other suitable attribute names, then compare this information against the attribute values in the item information to see if it matches. In a number of embodiments, the title interpreter model can be a fast natural language processing model that can interpret titles in terms of sequence of attribute values. The attribute values extracted from the title using the title interpreter model can be treated as a benchmark to assess the accuracy of given attribute values.

After it is built, in many embodiments, the title interpreter model can be used to assess the accuracy of a given attribute value for an item against the title of the item. For example, if the term “white” is included in the title of an item having a product type of T-shirts, the title interpreter can indicate that a precision score for the attribute value of “white” associated with the attribute name of “color” has that is high. Attribute values that are different than “white” for this item can have precision scores that are low. In several embodiments, the title interpreter model can be used to assess the accuracy of an attribute value associated with a product, based on the title of the product.

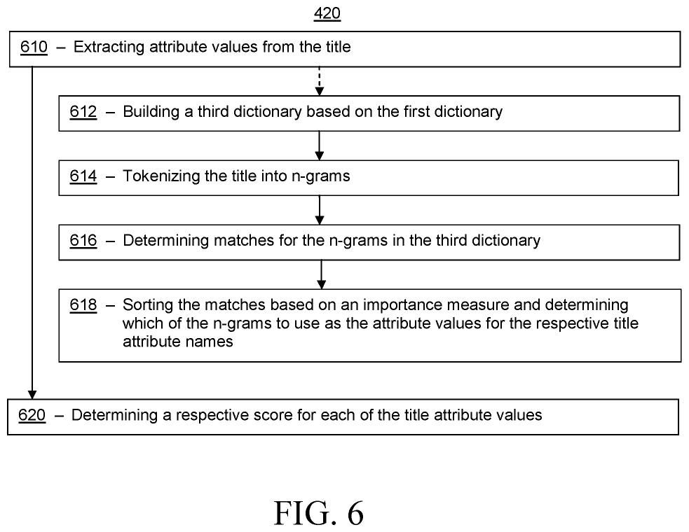

Turning ahead in the drawings, FIG. 6 illustrates a flow chart for block 420 of building a title interpreter model based on titles of the items in the item catalog, according to an embodiment. Block 420 is merely exemplary and is not limited to the embodiments presented herein. Block 420 can be employed in many different embodiments or examples not specifically depicted or described herein. In some embodiments, the procedures, the processes, and/or the activities of block 420 can be performed in the order presented. In other embodiments, the procedures, the processes, and/or the activities of block 420 can be performed in any suitable order. In still other embodiments, one or more of the procedures, the processes, and/or the activities of block 420 can be combined or skipped.

Referring to FIG. 6, block 420 can include a block 610 of extracting title attribute values from the title using a natural language processing matching and a conflict solver. In many embodiments, each of the title attribute values can be associated with a respective title attribute name.

In a number of embodiments, block 610 of extracting title attribute values from the title using a natural language processing matching and a conflict solver can optionally include a block 612 of building a third dictionary based on the first dictionary by exchanging a nesting level of the each respective attribute value with a nesting level of the each respective attribute name. In many embodiments, the third dictionary can provide a mapping from an attribute name for a particular attribute value and product type to the associated confidence score. In several embodiments, the third dictionary, D₃, can have a nested structure, as follows:

```
{Product type i:
  {Attribute value j:
    {Attribute name k: confidence score k}
  }
}
```

where there is a quantity of i product types in the dictionary, with each product type having a respective quantity of j attribute values, with each of the attribute values having a respective quantity of k attribute names, and each of the attribute names being mapped to a respective confidence score. The confidence score for an attribute name can be based on the confidence score that was generated for the associated attribute value for the first dictionary. In other words, the first dictionary can include i first level blocks for each of the product types. Within each of the first level blocks for a product type can be j second level blocks for each of the attribute values associated with that product type. Within each of the second level blocks for an attribute value can be k third level blocks for each of the attribute names associated with that attribute value. The quantity values of j and/or k can vary within each outer block, depending on respective quantities of associated attribute values and associated attribute names for the product type in the item catalog. The quantity value of i can be based on the number of product types in the item catalog.

In several embodiments, block 610 of extracting title attribute values from the title using a natural language processing matching and a conflict solver also can include with a block 614 of tokenizing the title into n-grams. In many embodiments, the title can be lemmatized before tokenizing the title, similarly as described above for lemmatizing attribute values. In a number of embodiments, the tokenizing of the title into n-grams can involve tokenizing the title into unigrams, then bi-grams, then tri-grams, then 4-grams, then 5-grams, such that n ranges from 1 to 5. Each of these n-grams can be referred to as a token.

For example, for an item with a title of “Personalized Monster Jam Dragon Steals the Show Black Boys' T-Shirt,” the unigrams are: [‘personalized’, ‘monster’, ‘jam’, ‘dragon’, ‘steal’, ‘the’, ‘show’, ‘black’, ‘boy’, ‘t’, ‘shirt’]; the bi-grams are: [‘personalized monster’, ‘monster jam’, ‘jam dragon’, ‘dragon steal’, ‘steal the’, ‘the show’, ‘show black’, ‘black boy’, ‘boy t’, ‘t shirt’]; the tri-grams are: [‘personalized monster jam’, ‘monster jam dragon’, ‘jam dragon steal,’ ‘dragon steal the’, ‘steal the show’, ‘the show black’, ‘show black boy’, ‘black boy t’, ‘boy t shirt’]; the 4-grams are: [‘personalized monster jam dragon’, ‘monster jam dragon steal’, ‘jam dragon steal the,’ ‘dragon steal the show’, ‘steal the show black’, ‘the show black boy’, ‘show black boy t’, ‘black boy t shirt’]; and the 5-grams are [‘personalized monster jam dragon steal’, ‘monster jam dragon steal the’, ‘jam dragon steal the show’, ‘dragon steal the show black’, ‘steal the show black boy’, ‘the show black boy t’, ‘show black boy t shirt’].

In a number of embodiments, block 610 of extracting title attribute values from the title using a natural language processing matching and a conflict solver additionally can include a block 616 of determining matches, for the n-grams, in the third dictionary for a product type associated with the item. In several embodiments, all possible matches for the n-grams in the third dictionary can be determined. In many embodiments, a match can exist then the n-gram matches an attribute value in the third dictionary. Each of the attribute names under the attribute value in the third dictionary can be separate matches. In many embodiments, each of the matches can be stored in a structure that includes various information about the match, such as the starting token index of the token in the title (referred to below in the exemplary matching results as ‘token_index_start’), the ending token index of the token in the title (referred to below as ‘token_index_end’), an importance of the matching result (referred to below as ‘importance’), an importance of the matching result (referred to below as ‘importance’), the starting character index of the token in the title (referred to below as ‘start’), the ending character index of the token in the title (referred to below as ‘token_index_end’), the matching attribute value from the third dictionary (referred to below as ‘matched_attr_value’), an attribute name associated with the attribute value in the third dictionary (referred to below as ‘entity’), the confidence score for the attribute name from the third dictionary (referred to below as ‘confidence’), and/or other suitable information. In a number of embodiments, the importance in the matching result can be the importance of the attribute name, which can be defined based on search and facet appearance. For example, certain attributes, such as color or brand, or often more important than other attributes. The importance of the different attribute names are generally pre-defined for each product type based on user engagement with the attribute name in search filtering or other contexts. A subset of the matches generated in block 616, when continuing the example described above in block 614, is shown below:

{‘token_index_start’: 1, ‘token_index_end’: 1, ‘importance’: 0.06936991189097877, ‘start’: 13, ‘end’: 20, ‘tokenName’: ‘Monster’, ‘matched_attr_value’: ‘Monster’, ‘entity’: ‘character’, ‘confidence’: 0.5374650184794351},

{‘token__index_start’: 1, ‘token_index_end’: 1, ‘importance’: 0.05301993265761871, ‘start’: 13, ‘end’: 20, ‘tokenName’: ‘Monster’, ‘matched_attr_value’: ‘Monster’, ‘entity’: ‘color’, ‘confidence’: 0.5000346734645197},

{‘token__index_start’: 1, ‘token_index_end’: 1, ‘importance’: 0.004509994271707501, ‘start’: 13, ‘end’: 20, ‘tokenName’: ‘Monster’, ‘matched_attr_value’: ‘Monster’, ‘entity’: ‘theme’, ‘confidence’: 1},

{‘token__index_start’: 1, ‘token_index_end’: 1, ‘importance’: 0.019809974838693685, ‘start’: 13, ‘end’: 20, ‘tokenName’: ‘Monster’, ‘matched_attr_value’: ‘Monster’, ‘entity’: ‘pattern’, ‘confidence’: 1},

{‘token_index_start’: 2, ‘token_index_end’: 2, ‘importance’: 0.15292980575885615, ‘start’: 21, ‘end’: 24, ‘tokenName’: ‘Jam’, ‘matched_attr_value’: ‘Jam’, ‘entity’: ‘brand’, ‘confidence’: 0.500591403884698},

{‘token__index_start’: 3, ‘token_index_end’: 3, ‘importance’: 0.03131996021949735, ‘start’: 25, ‘end’: 31, ‘tokenName’: ‘Dragon’, ‘matched_attr_value’: ‘Dragon’, ‘entity’: ‘sports team’, ‘confidence’: 0.503317089363598},

{‘token_index_start’: 3, ‘token_index_end’: 3, ‘importance’: 0.019809974838693685, ‘start’: 25, ‘end’: 31, ‘tokenName’: ‘Dragon’, ‘matched_attr_value’: ‘Dragon’, ‘entity’: ‘pattern’, ‘confidence’: 0.5003764893842778},

{‘token__index_start’: 3, ‘token_index_end’: 3, ‘importance’: 0.008099989711939351, ‘start’: 25, ‘end’: 31, ‘tokenName’: ‘Dragon’, ‘matched_attr_value’: ‘Dragon’, ‘entity’: ‘manufacturer’, ‘confidence’: 0.5019520115150656},

{‘token__index_start’: 4, ‘token_index_end’: 4, ‘importance’: 0.05301993265761871, ‘start’: 32, ‘end’: 38, ‘tokenName’: ‘Steals’, ‘matched_attr_value’: ‘Steals’, ‘entity’: ‘color’, ‘confidence’: 0.5003585235856175},

{‘token_index_start’: 7, ‘token_index_end’: 7, ‘importance’: 0.05301993265761871, ‘start’: 48, ‘end’: 53, ‘tokenName’: ‘Black’, ‘matched_attr_value’: ‘Black’, ‘entity’: ‘color’, ‘confidence’: 1},

{‘token__index_start’: 7, ‘token_index_end’: 7, ‘importance’: 0.019809974838693685, ‘start’: 48, ‘end’: 53, ‘tokenName’: ‘Black’, ‘matched_attr_value’: ‘Black’, ‘entity’: ‘pattern’, ‘confidence’: 0.5306832214202032},

{‘token__index_start’: 7, ‘token_index_end’: 7, ‘importance’: 0.0008999988568820157, ‘start’: 48, ‘end’: 53, ‘tokenName’: ‘Black’, ‘matched_attr_value’: ‘Black’, ‘entity’: ‘features’, ‘confidence’: 0.5029158618962412},

{‘token_index_start’: 7, ‘token_index_end’: 7, ‘importance’: 1e-05, ‘start’: 48, ‘end’: 53, ‘tokenName’: ‘Black’, ‘matched_attr_value’: ‘Black’, ‘entity’: ‘finish’, ‘confidence’: 1},

{‘token_index_start’: 7, ‘token_index_end’: 7, ‘importance’: 0.0026999965706450803, ‘start’: 48, ‘end’: 53, ‘tokenName’: ‘Black’, ‘matched_attr_value’: ‘Black’, ‘entity’: ‘color category’, ‘confidence’: 1},

{‘token__index_start’: 8, ‘token_index_end’: 8, ‘importance’: 0.261799667479651, ‘start’: 54, ‘end’: 58, ‘tokenName’: ‘Boys’, ‘matched_attr_value’: ‘Boys’, ‘entity’: ‘clothing_size_group’, ‘confidence’: 1},

{‘token__index_start’: 8, ‘token_index_end’: 8, ‘importance’: 0.004499994284406256, ‘start’: 54, ‘end’: 58, ‘tokenName’: ‘Boys’, ‘matched_attr_value’: ‘Boys’, ‘entity’: ‘age_demographic’, ‘confidence’: 1},

{‘token__index_start’: 10, ‘token_index_end’: 10, ‘importance’: 0.022499971422043404, ‘start’: 61, ‘end’: 66, ‘tokenName’: ‘Shirt’, ‘matched_attr_value’: ‘Shirt’, ‘entity’: ‘clothing_style’, ‘confidence’: 1.0},

{‘token__index_start’: 10, ‘token_index_end’: 10, ‘importance’: 0.012599983996347026, ‘start’: 61, ‘end’: 66, ‘tokenName’: ‘Shirt’, ‘matched_attr_value’: ‘Shirt’, ‘entity’: ‘style_clothing_top’, ‘confidence’: 1.0},

{‘token__index_start’: 10, ‘token_index_end’: 10, ‘importance’: 0.007209990842341827, ‘start’: 61, ‘end’: 66, ‘tokenName’: ‘Shirt’, ‘matched_attr_value’: ‘Shirt’, ‘entity’: ‘pant_style’, ‘confidence’: 1.0},

{‘token__index_start’: 10, ‘token_index_end’: 10, ‘importance’: 0.0017999977137640314, ‘start’: 61, ‘end’: 66, ‘tokenName’: ‘Shirt’, ‘matched_attr_value’: ‘Shirt’, ‘entity’: ‘collar type’, ‘confidence’: 1},

{‘token__index_start’: 1, ‘token_index_end’: 2, ‘importance’: 0.15292980575885615, ‘start’: 13, ‘end’: 24, ‘tokenName’: ‘Monster Jam’, ‘matched_attr_value’: ‘Monster Jam’, ‘entity’: ‘brand’, ‘confidence’: 0.5008398190773552},

{‘token_index_start’: 1, ‘token_index_end’: 2, ‘importance’: 0.06936991189097877, ‘start’: 13, ‘end’: 24, ‘tokenName’: ‘Monster Jam’, ‘matched_attr_value’: ‘Monster Jam’, ‘entity’: ‘character’, ‘confidence’: 0.5168653497568464},

{‘token__index_start’: 1, ‘token_index_end’: 2, ‘importance’: 0.005399993141290161, ‘start’: 13, ‘end’: 24, ‘tokenName’: ‘Monster Jam’, ‘matched_attr_value’: ‘Monster Jam’, ‘entity’: ‘global_brand_license’, ‘confidence’: 0.5107654412381449},

{‘token__index_start’: 8, ‘token_index_end’: 9, ‘importance’: 0.008099989711939351, ‘start’: 54, ‘end’: 60, ‘tokenName’: ‘Boys T’, ‘matched_attr_value’: ‘Boys T’, ‘entity’: ‘manufacturer’, ‘confidence’: 0.5014193750701729},

{‘token__index_start’: 8, ‘token_index_end’: 9, ‘importance’: 0.15292980575885615, ‘start’: 54, ‘end’: 60, ‘tokenName’: ‘Boys T’, ‘matched_attr_value’: ‘Boys T’, ‘entity’: ‘brand’, ‘confidence’: 0.5003307662679085},

{‘token__index_start’: 9, ‘token_index_end’: 10, ‘importance’: 1e-05, ‘start’: 59, ‘end’: 66, ‘tokenName’: ‘T Shirt’, ‘matched_attr_value’: ‘T Shirt’, ‘entity’: ‘product type’, ‘confidence’: 1},

{‘token__index_start’: 9, ‘token_index_end’: 10, ‘importance’: 0.022499971422043404, ‘start’: 59, ‘end’: 66, ‘tokenName’: ‘T Shirt’, ‘matched_attr_value’: ‘T Shirt’, ‘entity’: ‘clothing_style’, ‘confidence’: 1.0},

{‘token__index_start’: 9, ‘token_index_end’: 10, ‘importance’: 0.012599983996347026, ‘start’: 59, ‘end’: 66, ‘tokenName’: ‘T Shirt’, ‘matched_attr_value’: ‘T Shirt’, ‘entity’: ‘style_clothing_top’, ‘confidence’: 1.0},

{‘token__index_start’: 9, ‘token_index_end’: 10, ‘importance’: 0.0026999965706450803, ‘start’: 59, ‘end’: 66, ‘tokenName’: ‘T Shirt’, ‘matched_attr_value’: ‘T Shirt’, ‘entity’: ‘t_shirt_type’, ‘confidence’: 1},

{‘token_index_start’: 9, ‘token_index_end’: 10, ‘importance’: 1e-05, ‘start’: 59, ‘end’: 66, ‘tokenName’: ‘T Shirt’, ‘matched_attr_value’: ‘T Shirt’, ‘entity’: ‘bra_style’, ‘confidence’: 1}

In several embodiments, block 610 of extracting title attribute values from the title using a natural language processing matching and a conflict solver further can include with a block 618 of sorting the matches based at least in part on an importance measure of attribute values in the matches and determining which of the n-grams to use as the attribute values for the respective title attribute names. In many embodiments, block 618 can implement the conflict solver. In a number of embodiments, block 618 can involve determining suitable matches between the attribute names and the attribute values using the conflict solver. As observed from the matching results listed above, the same token can be mapped to the multiple attribute names. Conversely, the same attribute name can be mapped to multiple tokens. For example, attribute name of color can be mapped to the tokens of “Monster,” “Steals,” and “Black.” In many embodiments, the conflict solver can determine which token to use as the attribute value for the attribute name. In many embodiments, the conflict solver can be based sort the matching results by attribute importance, confidence, and token length in a descending order, such that the attribute name to use can be based on attribute importance, confidence, and/or token length. In some embodiments, the conflict solver can be implemented based on the pseudo-code shown in Algorithm 1 below. In several embodiments, the tokens mapped to attribute names can be used as the title attribute values for the title interpreter model.

```
Algorithm 1: Conflict Solver
# sort the matching result from by importance, confidence,
and token length of attribute name in a descending order
matchings.sort(key=lambda x: (x[‘importance’],
x[‘confidence’], x[‘end’]−x[‘start’]), reverse=True)
# determine which token to use as the attribute value for
the attribute name
for token in matchings:
  if the confidence of token to current attribute name is
  smaller than 0.55:
    if this token can be matched to other important
    attribute name and achieve the confidence larger than
    0.9:
        continue
    if token and next token map to the same attribute name
    and the length of next token is longer than that of
    current token and the confidence difference between them
    is less than 0.05:
      continue
map this token to the current attribute name
```

In a number of embodiments, block 420 further can include a block 620 (after block 610) of determining a respective score for the respective title attribute name associated with the each of the title attribute values. In many embodiments, the score for a title attribute name can be determined by evaluating the title interpreter model against a golden dataset. In a number of embodiments, the golden dataset can be obtained through a experts and/or a crowdsource team. The golden dataset can include labels of ground truth of attributes values for a large amount of data. The title interpreter model can be compared to the golden dataset to determine a percentage of correct prediction, which can be treated as a model precision score, and which can be used as the score for an attribute name. For example, the model precision for an attribute name of color category can be 0.95, so the score can be 0.95.

In a number of embodiments, once an item has been processed through the title interpreter, a structure can be generated to store attribute values that were extracted (in the title_attribute_value_suggestion block below) and associated scores for one of more of these extracted attribute values (in the title_attribute_value_precision block):

```
{“model_version”: “20190801-232455”, “product_Type”:
“T-Shirts”, “title”:
“Personalized Monster Jam Dragon Steals the Show Black Boys' T-Shirt”,
  “title_attribute_value_precision”: {
    “clothing_size_group”: {“Boys”: 0.77},
    “color_category”: {“Black”: 0.95}
  },
  “title_attribute_value_suggestion”: {
    “age_demographic”: “Boys”,
    “brand”: “Monster Jam”,
    “character”: “Monster Jam”,
    “clothing_size_group”: “Boys”,
    “clothing_style”: “T-Shirt”,
    “collar_type”: “Shirt”,
    “color”: “Black”,
    “color_category”: “Black”,
    “finish”: “Black”,
    “global_brand_license”: “Monster Jam”,
    “pattern”: “Monster”,
    “style_clothing_top”: “T-Shirt”,
    “theme”: “Monster”
  }
}
```

Returning to FIG. 4, in several embodiments, method 400 additionally can include with a block 430 of retrieving target attribute values that are associated with a target attribute name of a target item in the item catalog. In many embodiments, the target attribute values having been received from multiple sources. An item (referred to as the “target item”) can be an item that has multiple attribute values (referred to as the “target attribute values”) for a particular attribute name (referred to as the “target attribute name”). In many embodiments, the target attribute values can be item information that was received for the item by multiple different content sources, such as suppliers.

For example, a particular type of T-shirt can be a target item having associated item information, such as a T-shirt with a title “Mens White Short-Sleeve Diamond Skull T-Shirt.” There can be multiple sources of item information for the target item. Multiple suppliers supplied the target item for the online platform provided by web server 320 (FIG. 3), and each supplier inputted item information for the target item. For example, for the target attribute name of “color category,” there can be five sources, sources A-E, that each provided a target attribute value. Source A indicated that the target attribute value for the target item is “generic.” Similarly, source B indicated that the target attribute value for the target item is “generic.” Source C indicated that the target attribute value for the target item is “white.” Source D indicated that the target attribute value for the target item is “pink.” Source E indicated that the target attribute value for the target item is “generic.”

In a number of embodiments, method 400 further can include a block 440 of generating a respective relevancy score for each one of the target attribute values using the relevancy model. In many embodiments, block 440 of generating a respective relevancy score for each one of the target attribute values using the relevancy model can include, for a target attribute value of the target attribute values, determining if the target attribute value is included in the first dictionary. When the target attribute value is included in the first dictionary, the respective relevancy score can be generated by using the respective confidence score for the target attribute value as the respective relevancy score for the target attribute value. When the target attribute value is not included in the first dictionary, the respective relevancy score can be generated by determining the respective relevance score for the target attribute value based on a cosine similarity measure between (a) the respective semantic centroid for an attribute name associated with the target attribute value in the second dictionary and (b) a glove word embedding of the target attribute value. In many embodiments, the target attribute value can be lemmatized and concatenated before determining if the target attribute value is included in the first dictionary.

For example, for the target attribute value of “generic” provided by source A, block 440 can involve determining whether there is an attribute value of “generic” in the first dictionary under the product type of “T-shirt” and attribute name of “color category.” If the attribute value of “generic” is included in the first dictionary D₁, then the confidence score included in the first dictionary D₁ can be used as the relevance score of the target attribute value of “generic” provided by source A.

If there is no entry in the first dictionary D₁ for an attribute value of “generic” under the product type of “T-shirt” and attribute name of “color category,” the second dictionary D₂ can be used to determine the relevance score. For example, the semantic centroid score associated with attribute name of “color category” for the product type of “T-shirt” can retrieved from the second dictionary D₂. The glove word embedding for the attribute value of “generic” can be calculated. Then, the cosine similarity measure can be used to determine the distance between the semantic centroid score and the glove word embeddings. This cosine similarity measure can be used as the relevance score of the target attribute value of “generic” provided by source A. Because the cosine similarity measure can have outputs ranging from −1 to 1, the values that are calculated to be less than 0 can be set to 0. In many embodiments, the respective relevancy score can be set to the cosine similarity measure that is determined.

In many embodiments, relevance scores can be calculated for all of the target attribute values from the various different sources, as described above, either using the confidence score in the first dictionary, or using the semantic centroid score in the second dictionary, as applicable. For example, the relevancy score for the target attribute value of “generic” provided by source A can be calculated to be 0.24, the relevancy score for the target attribute value of “generic” provided by source B can be calculated to be 0.24, the relevancy score for the target attribute value of “white” provided by source C can be calculated to be 1, the relevancy score for the target attribute value of “pink” provided by source D can be calculated to be 1, and the relevancy score for the target attribute value of “generic” provided by source E can be calculated to be 0.24.

In several embodiments, method 400 additionally can include with a block 450 of generating a respective precision score for the each one of the target attribute values based on the title interpreter model. In many embodiments, block 450 of generating a respective precision score for the each one of the target attribute values based on the title interpreter model can include, for a target attribute value of the target attribute values, determining if a match exists between (a) the target attribute value and (b) a title attribute value of the title attribute values that is associated with the respective title attribute name that matches the target attribute name. When the match exists, the respective precision score can be generated by using the respective score of the respective title attribute name as the respective precision score for the target attribute value. When the match does not exist, the respective precision score can be generated by using a complement of the respective score of the title attribute name as the respective precision score for the target attribute value.

For example, for the target attribute value of “white” provided by source C, block 450 can involve determining whether there is a match between the target attribute value of “white” and the title attribute value that is associated with the title attribute name of “color category” for this item. For this item, the title includes the term “white” as a token, and the title interpreter extracted “white” as a title attribute value for the item for the title attribute name of “color category.” Thus, the target attribute value of “white” provided by source C matches with the title attribute value of “white” for the title attribute name of “color category” for this item. As such, the precision score for this target attribute value for source C can be the score generated by the title interpreter model for the attribute name of “color category,” which in this case can be 0.95. For source A, the target attribute value of “generic” provided by source A does not match with the title attribute value of “white” for the title attribute name of “color category” for this item. As such, the precision score for this target attribute value for source A can be the complement of the score generated by the title interpreter model for the attribute name of “color category,” which in this case can be 1-0.95=0.05. Similarly, the precision score for the target attribute value of “generic” provided in sources B and E, and the target attribute value of “pink” provided in source D, can be 0.05, as the target attribute value does not match the title attribute value of “white.”

In a number of embodiments, method 400 further can include a block 460 of determining a respective weight for the each one of the target attribute values based on the respective relevancy score for the each one of the target attribute values and the respective precision score for the each one of the target attribute values. In many embodiments, an accuracy score can be determined for each target attribute value can by multiplying the relevancy score by the precision score. In several embodiments, the weight can then be determined by weighting the accuracy scores, based on a total of all the accuracy scores.

For example, the accuracy score for the target attribute value of “generic” provided by source A can be calculated by multiplying the relevancy score of 0.24 by the precision score of 0.05, to output an accuracy score of 0.012. Similarly, the accuracy score for the target attribute value of “generic” provided by source B can be calculated by multiplying the relevancy score of 0.24 by the precision score of 0.05, to output an accuracy score of 0.012. The accuracy score for the target attribute value of “white” provided by source C can be calculated by multiplying the relevancy score of 1 by the precision score of 0.95, to output an accuracy score of 0.95. The accuracy score for the target attribute value of “pink” provided by source D can be calculated by multiplying the relevancy score of 1 by the precision score of 0.05, to output an accuracy score of 0.05. The accuracy score for the target attribute value of “generic” provided by source E can be calculated by multiplying the relevancy score of 0.24 by the precision score of 0.05, to output an accuracy score of 0.012. The total of all the accuracy scores can be 1.036. The weight for the target attribute value of “generic” can be the sum of its accuracy scores (0.012+0.012+0.012) divided by the total of 1.036, to output a weight of 3.5%. The weight for the target attribute value of “white” can be calculated by taking its accuracy score (0.95) and then dividing by the total of 1.036, to output a weight of 91.2%. The weight for the target attribute value of “pink” can be calculated by taking its accuracy score (0.05) and then dividing by the total of 1.036, to output a weight of 4.8%.

In several embodiments, method 400 additionally can include with a block 470 of selecting a winning attribute value for the target attribute name of the target item from among the target attribute values, based on the respective weights for the target attribute values. For example, continuing with the example weights described in block 460, the winning attribute value can be “white,” as the weight for “white” is higher than the weight for any of the other values. The attribute value of “white” can thus be selected as the correct value. In many embodiments, the attribute values of “pink” and “generic” can be flagged as inaccurate. In a number of embodiments, when an attribute value is flagged, the attribute value is likely inaccurate, which can be reviewed by a reviewer, to be corrected. In many embodiments, the winning value can be suggested to the reviewer as the correct value. The reviewer can be a specialist, the supplier that provided the information, or another suitable person.

In some embodiments, the winning attribute value can be used to automatically replace the other attribute values provided by the other sources. In various embodiments, a threshold can be used to determine whether a weight for an attribute value is low enough that it should be flagged or replaced. For example, a threshold of 33% can be used, such that any attribute values have a weight less than 33% can be flagged and/or replaced by the winning attribute value. In other embodiments, another suitable threshold can be used.

In some embodiments, the accuracy score and/or the weight calculated for each attribute value provided by a score can be associated with that attribute value. In several embodiments, this information can be displayed along with the attribute value to analysts, and/or incorporated in statistical analysis that is displayed to analysts. In some embodiments, when item information is being entered, such as an item being added by a supplier, the accuracy score and/or weight can be calculated for an attribute value included in the information, to notify the supplier if the information being entered does not appear to be accurate. In many embodiments, the attribute scores, weights, and/or winning values can be used in other suitable applications.

Returning to FIG. 3, in several embodiments, communication system 311 can at least partially perform block 430 (FIG. 4) of retrieving target attribute values that are associated with a target attribute name of a target item in the item catalog; and/or block 470 (FIG. 4) of selecting a winning attribute value for the target attribute name of the target item from among the target attribute values, based on the respective weights for the target attribute values.

In several embodiments, relevancy model system 312 can at least partially perform block 410 (FIG. 4) of building a relevancy model based on items in an item catalog; block 440 (FIG. 4) of generating a respective relevancy score for each one of the target attribute values using the relevancy model; block 510 (FIG. 5) of building a first dictionary; block 512 (FIG. 5) of filtering out attribute values such that, for each excluded attribute value associated with an attribute name and a product type, a quantity of items associated with the excluded attribute value is fewer than a predetermined threshold; block 514 (FIG. 5) of generating the respective confidence score for the each respective filtered attribute value that is associated with the each respective attribute name that is associated with the each product type of the items in the item catalog; block 516 (FIG. 5) of adding taxonomy data to the first dictionary; and/or block 518 (FIG. 5) of assigning a high confidence score for each attribute value added by the taxonomy data; block 520 (FIG. 5) of building a second dictionary.

In a number of embodiments, title interpreter model system 313 can at least partially perform block 420 (FIG. 4) of building a title interpreter model based on titles of the items in the item catalog; block 450 (FIG. 4) of generating a respective precision score for the each one of the target attribute values based on the title interpreter model; block 610 (FIG. 6) of extracting title attribute values from the title using a natural language processing matching and a conflict solver; block 612 (FIG. 6) of building a third dictionary based on the first dictionary by exchanging a nesting level of the each respective attribute value with a nesting level of the each respective attribute name; block 614 (FIG. 6) of tokenizing the title into n-grams; block 616 (FIG. 6) of determining matches, for the n-grams, in the third dictionary for a product type associated with the item; block 618 (FIG. 6) of sorting the matches based at least in part on an importance measure of attribute values in the matches and determining which of the n-grams to use as the attribute values for the respective title attribute names; and/or block 620 (FIG. 6) of determining a respective score for the respective title attribute name associated with the each of the title attribute values.

In several embodiments, attribute scoring system 314 can at least partially perform block 430 (FIG. 4) of retrieving target attribute values that are associated with a target attribute name of a target item in the item catalog; block 440 (FIG. 4) of generating a respective relevancy score for each one of the target attribute values using the relevancy model; block 450 (FIG. 4) of generating a respective precision score for the each one of the target attribute values based on the title interpreter model; block 460 (FIG. 4) of determining a respective weight for the each one of the target attribute values based on the respective relevancy score for the each one of the target attribute values and the respective precision score for the each one of the target attribute values; and/or block 470 of (FIG. 4) selecting a winning attribute value for the target attribute name of the target item from among the target attribute values, based on the respective weights for the target attribute values.

In a number of embodiments, web server 320 can at least partially perform block 430 of (FIG. 4) retrieving target attribute values that are associated with a target attribute name of a target item in the item catalog; and/or block 470 of (FIG. 4) selecting a winning attribute value for the target attribute name of the target item from among the target attribute values, based on the respective weights for the target attribute values.

In many embodiments, the techniques described herein can provide a practical application and several technological improvements. In some embodiments, the techniques described herein can provide for automatically determining the quality of attribute values for items in an item catalog. These techniques described herein can provide a significant improvement over conventional approaches of assuming that attribute values entered by a source (e.g., a supplier) is correct. In a number of embodiments, the techniques described herein can detect inaccurate data, using determinations made from various signals to make a determination on whether an attribute value is accurate and, if not, what the correct value should be.

In many embodiments, the techniques described herein can beneficially generate a relevancy model and a title interpreter model, which can be used to learn the quality of an attribute value. In many embodiments, the techniques described herein can be used continuously at a scale that cannot be handled using manual techniques. For example, the number of unique items can be over 200 million, and there can be hundreds of thousands of updates to attribute values that are received daily.

In a number of embodiments, the techniques described herein can solve a technical problem that arises only within the realm of computer networks, as online ordering do not exist outside the realm of computer networks. Moreover, the techniques described herein can solve a technical problem that cannot be solved outside the context of computer networks. Specifically, the techniques described herein cannot be used outside the context of computer networks, in view of a lack of data.

Various embodiments can include a system including one or more processors and one or more non-transitory computer-readable media storing computing instructions configured to run on the one or more processors and perform certain acts. The acts can include building a relevancy model based on items in an item catalog. The acts also can include building a title interpreter model based on titles of the items in the item catalog. The acts additionally can include retrieving target attribute values that are associated with a target attribute name of a target item in the item catalog. The target attribute values can be received from multiple sources. The acts further can include generating a respective relevancy score for each one of the target attribute values using the relevancy model. The acts additionally can include generating a respective precision score for the each one of the target attribute values based on the title interpreter model. The acts further can include determining a respective weight for the each one of the target attribute values based on the respective relevancy score for the each one of the target attribute values and the respective precision score for the each one of the target attribute values. The acts additionally can include selecting a winning attribute value for the target attribute name of the target item from among the target attribute values, based on the respective weights for the target attribute values.

A number of embodiments can include a method being implemented via execution of computing instructions configured to run at one or more processors and stored at one or more non-transitory computer-readable media. The method can include building a relevancy model based on items in an item catalog. The method also can include building a title interpreter model based on titles of the items in the item catalog. The method additionally can include retrieving target attribute values that are associated with a target attribute name of a target item in the item catalog. The target attribute values can be received from multiple sources. The method further can include generating a respective relevancy score for each one of the target attribute values using the relevancy model. The method additionally can include generating a respective precision score for the each one of the target attribute values based on the title interpreter model. The method further can include determining a respective weight for the each one of the target attribute values based on the respective relevancy score for the each one of the target attribute values and the respective precision score for the each one of the target attribute values. The method additionally can include selecting a winning attribute value for the target attribute name of the target item from among the target attribute values, based on the respective weights for the target attribute values.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically determining the quality of attribute values for items in an item catalog has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIGS. 4-6 may include different procedures, processes, and/or activities and be performed by many different modules, in many different orders. As another example, one or more of the procedures, processes, and/or activities of one of FIGS. 4-6 can be performed in another one of FIGS. 4-6. As another example, the systems within system 300 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and perform:
building a relevancy model based on items in an item catalog;
building a title interpreter model based on titles of the items in the item catalog;
retrieving target attribute values that are associated with a target attribute name of a target item in the item catalog, the target attribute values having been received from multiple sources;
generating a respective relevancy score for each one of the target attribute values using the relevancy model;
generating a respective precision score for the each one of the target attribute values based on the title interpreter model;
determining a respective weight for the each one of the target attribute values based on the respective relevancy score for the each one of the target attribute values and the respective precision score for the each one of the target attribute values; and
selecting a winning attribute value for the target attribute name of the target item from among the target attribute values, based on the respective weights for the target attribute values.

2. The system of claim 1, wherein building the relevancy model further comprises:
building a first dictionary comprising a respective confidence score for each respective filtered attribute value that is associated with each respective attribute name that is associated with each product type of the items in the item catalog; and
building a second dictionary comprising a respective semantic centroid score for the each respective attribute name that is associated with the each product type of the items in the item catalog.

3. The system of claim 2, wherein building the first dictionary further comprises:
filtering out attribute values such that, for each excluded attribute value associated with an attribute name and a product type, a quantity of items associated with the excluded attribute value is fewer than a predetermined threshold; and
generating the respective confidence score for the each respective filtered attribute value that is associated with the each respective attribute name that is associated with the each product type of the items in the item catalog.

4. The system of claim 3, wherein building the first dictionary further comprises:
adding taxonomy data to the first dictionary; and
assigning a high confidence score for each attribute value added by the taxonomy data.

5. The system of claim 3, wherein generating the respective confidence score for the each respective filtered attribute value further comprises:
using term frequency-inverse document frequency (TF-IDF) to determine the respective confidence score for the each respective filtered attribute value.

6. The system of claim 2, wherein building the second dictionary further comprises:
determining the respective semantic centroid score for the each respective attribute name based on a weighted average of glove word embeddings for the respective filtered attributes values that are associated with the each respective attribute name.

7. The system of claim 2, wherein generating the respective relevancy score for the each one of the target attribute values further comprises, for a target attribute value of the target attribute values:
determining if the target attribute value is included in the first dictionary;
when the target attribute value is included in the first dictionary:
using the respective confidence score for the respective filtered attribute value in the first dictionary that matches the target attribute value as the respective relevancy score for the target attribute value; and
when the target attribute value is not included in the first dictionary:
determining the respective relevance score for the target attribute value based on a cosine similarity measure between (a) the respective semantic centroid for an attribute name associated with the target attribute value in the second dictionary and (b) a glove word embedding of the target attribute value.

8. The system of claim 2, wherein building the title interpreter model further comprises, for a respective title of the titles associated with a respective item in the item catalog:
extracting title attribute values from the respective title using a natural language processing matching and a conflict solver, each of the title attribute values being associated with a respective title attribute name;
determining a respective score for the respective title attribute name associated with the each of the title attribute values.

9. The system of claim 8, wherein extracting the attribute values from the respective title using the natural language processing matching and the conflict solver further comprises:
building a third dictionary based on the first dictionary by exchanging a nesting level of the each respective attribute value with a nesting level of the each respective attribute name;
tokenizing the respective title into n-grams;
determining matches, for the n-grams, in the third dictionary for a product type associated with the item; and
sorting the matches based at least in part on an importance measure of attribute values in the matches and determining which of the n-grams to use as the attribute values for the respective title attribute names.

10. The system of claim 8, wherein generating the respective precision score for the each one of the target attribute values further comprises, for a target attribute value of the target attribute values:
determining if a match exists between (a) the target attribute value and (b) a title attribute value of the title attribute values that is associated with the respective title attribute name that matches the target attribute name;
when the match exists:
using the respective score of the respective title attribute name as the respective precision score for the target attribute value; and
when the match does not exist:
using a complement of the respective score of the respective title attribute name as the respective precision score for the target attribute value.

11. A method being implemented via execution of computing instructions configured to run at one or more processors and stored at one or more non-transitory computer-readable media, the method comprising:
building a relevancy model based on items in an item catalog;
building a title interpreter model based on titles of the items in the item catalog;
retrieving target attribute values that are associated with a target attribute name of a target item in the item catalog, the target attribute values having been received from multiple sources;
generating a respective relevancy score for each one of the target attribute values using the relevancy model;
generating a respective precision score for the each one of the target attribute values based on the title interpreter model;
determining a respective weight for the each one of the target attribute values based on the respective relevancy score for the each one of the target attribute values and the respective precision score for the each one of the target attribute values; and
selecting a winning attribute value for the target attribute name of the target item from among the target attribute values, based on the respective weights for the target attribute values.

12. The method of claim 11, wherein building the relevancy model further comprises:
building a first dictionary comprising a respective confidence score for each respective filtered attribute value that is associated with each respective attribute name that is associated with each product type of the items in the item catalog; and
building a second dictionary comprising a respective semantic centroid score for the each respective attribute name that is associated with the each product type of the items in the item catalog.

13. The method of claim 12, wherein building the first dictionary further comprises:
filtering out attribute values such that, for each excluded attribute value associated with an attribute name and a product type, a quantity of items associated with the excluded attribute value is fewer than a predetermined threshold; and
generating the respective confidence score for the each respective filtered attribute value that is associated with the each respective attribute name that is associated with the each product type of the items in the item catalog.

14. The method of claim 13, wherein building the first dictionary further comprises:
adding taxonomy data to the first dictionary; and
assigning a high confidence score for each attribute value added by the taxonomy data.

15. The method of claim 13, wherein generating the respective confidence score for the each respective filtered attribute value further comprises:
using term frequency-inverse document frequency (TF-IDF) to determine the respective confidence score for the each respective filtered attribute value.

16. The method of claim 12, wherein building the second dictionary further comprises:
determining the respective semantic centroid score for the each respective attribute name based on a weighted average of glove word embeddings for the respective filtered attributes values that are associated with the each respective attribute name.

17. The method of claim 12, wherein generating the respective relevancy score for the each one of the target attribute values further comprises, for a target attribute value of the target attribute values:
determining if the target attribute value is included in the first dictionary;
when the target attribute value is included in the first dictionary:
using the respective confidence score for the respective filtered attribute value in the first dictionary that matches the target attribute value as the respective relevancy score for the target attribute value; and
when the target attribute value is not included in the first dictionary:
determining the respective relevance score for the target attribute value based on a cosine similarity measure between (a) the respective semantic centroid for an attribute name associated with the target attribute value in the second dictionary and (b) a glove word embedding of the target attribute value.

18. The method of claim 12, wherein building the title interpreter model further comprises, for a respective title of the titles associated with a respective item in the item catalog:
extracting title attribute values from the respective title using a natural language processing matching and a conflict solver, each of the title attribute values being associated with a respective title attribute name;
determining a respective score for the respective title attribute name associated with the each of the title attribute values.

19. The method of claim 18, wherein extracting the attribute values from the respective title using the natural language processing matching and the conflict solver further comprises:
building a third dictionary based on the first dictionary by exchanging a nesting level of the each respective attribute value with a nesting level of the each respective attribute name;
tokenizing the respective title into n-grams;
determining matches, for the n-grams, in the third dictionary for a product type associated with the item; and
sorting the matches based at least in part on an importance measure of attribute values in the matches and determining which of the n-grams to use as the attribute values for the respective title attribute names.

20. The method of claim 18, wherein generating the respective precision score for the each one of the target attribute values further comprises, for a target attribute value of the target attribute values:
determining if a match exists between (a) the target attribute value and (b) a title attribute value of the title attribute values that is associated with the respective title attribute name that matches the target attribute name;
when the match exists:
using the respective score of the respective title attribute name as the respective precision score for the target attribute value; and
when the match does not exist:
using a complement of the respective score of the title attribute name as the respective precision score for the respective target attribute value.
